(19) United States
(12) Patent Application Publication
(10) Pub. No.: US 2022/0042276 A1
(43) Pub. Date: Feb. 10, 2022

(54) Slidable Hydrovac Tank

(71) Applicant: Robert Carl Rajewski, Stettler (CA)

(72) Inventor: Robert Carl Rajewski, Stettler (CA)

(21) Appl. No.: 17/210,179

(22) Filed: Mar. 23, 2021

(30) Foreign Application Priority Data
Mar. 23, 2020 (CA) 3076715

(51) Int. Cl. E02F 3/88; E02F 9/22

(52) U.S. Cl. CPC E02F 3/8816; E02F 9/22

(57) ABSTRACT

A hydrovac with an engine compartment, cab, chassis frame and wheels, blower module, boom and a combined mud and water tank that has sliding rails, mounted to the chassis frame. The mud and water tank slide relative to the truck chassis on rails. The tanks move rearward and forward relative the truck chassis.

### FIELD

Hydrovacs

### BACKGROUND

Hydrovacs must comply with government regulations concerning load distribution on load supporting elements, such as the wheels of the hydrovacs. Considering that the load carried by a hydrovac varies during operation of the vehicle, this can result in sub-optimal load carrying. This has become a large issue in the industry but, despite various efforts, current attempts at solutions have drawbacks.

### SUMMARY

A hydrovac is provided having a chassis and wheels, and a structure mounted for forward and backward movement relative to the chassis to re-distribute load on the wheels.

### BRIEF DESCRIPTION OF THE DRAWINGS

Embodiments of a hydrovac will now be described with reference to the drawings by way of example, in which:

FIG. 1 shows a hydrovac with a sliding structure in a rearward position.

FIG. 2 shows a hydrovac with a sliding structure in a forward position.

FIG. 3 shows a sliding structure comprising a fluid tank.

FIG. 4 shows mounting of a sliding structure.

FIG. 5 shows a hydrovac with a sliding structure with separate water and mud tanks.

FIG. 6 shows a hydrovac with a sliding structure and a van body set back from the cab.

FIG. 7 shows a hydrovac with a sliding structure and a sweep.

### DETAILED DESCRIPTION

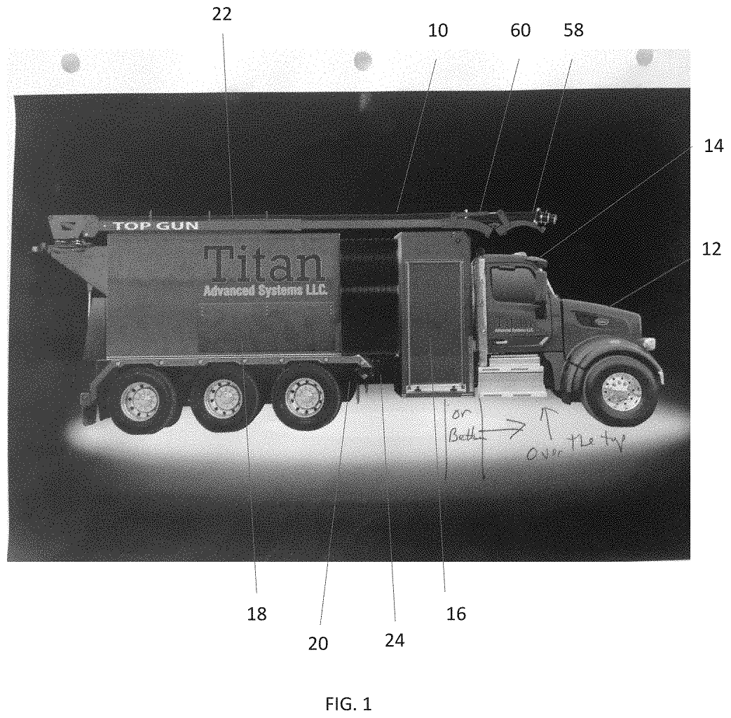

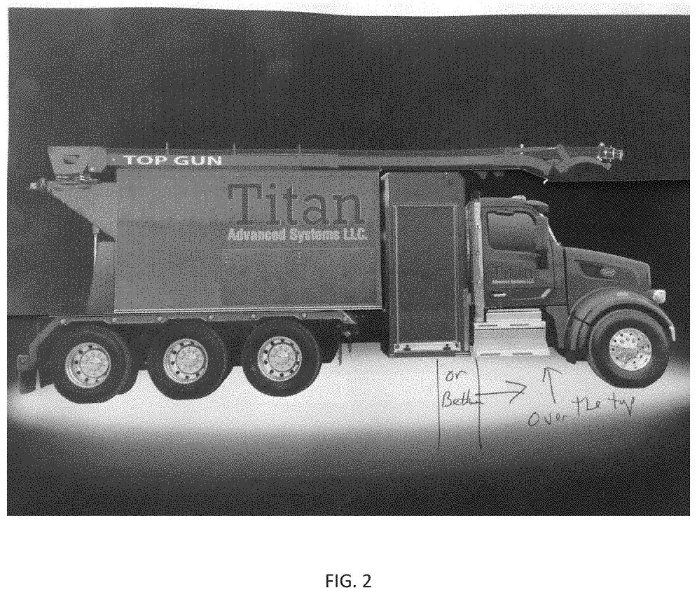

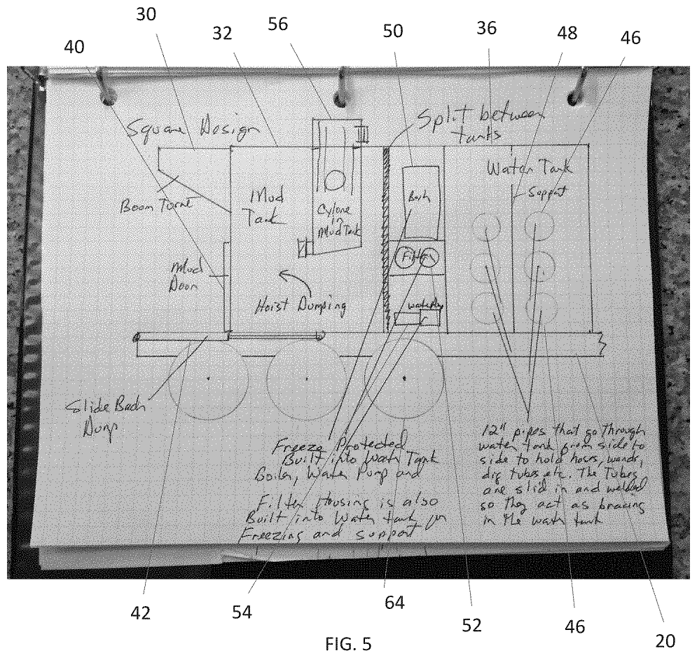

This application includes FIG. 1 and FIG. 2. FIG. 1 and FIG. 2 show a hydrovac vehicle 10 with engine compartment 12, cab 14, wheels 64, mechanical box 16, combined mud and water tank 18, truck chassis 20 and boom 22. A water pump and blower, among other normal components of a hydrovac, may be incorporated into the water portion of the tank, in the same manner as shown in FIG. 5. The mud and water tank 18 slide relative to the truck chassis 20 on rails 24. FIG. 1 shows the tanks moved rearward relative the truck chassis while FIG. 2 shows the tanks moved forward relative to the truck chassis. The mechanical box may be used to store items such as coats, boots, gloves and other items used by the hydrovac operator.

In the sliding design as shown in FIG. 1, the water load in the front of the tank is slid back over the rear wheels 64 the maximum amount to have maximum steering weight for control and not be over weight because the load goes to the back axles.

In order to haul the maximum load of mud away from the job site, an operator may slide the tank forward all the way to the van body as shown in FIG. 2 and all the mud weight at the back of the tank goes over the wheels and onto the front axles, to maximize gross axle weights.

In the tank (could be one tank with separate compartments, or two tanks joined together), the front is water and the back is mud.

There is a hydraulic cylinder 60 attached to a boom end 58, which lifts up the end 58 of the boom cradle so the boom hose stays straight so it is easier to work with once you get to the job site and also gets out of the visual sight of the driver. The boom 22 may be mounted on the passenger side as far as it can go to give more reach, more room, and most of all, to make it easier to work closer to the truck without the boom hitting the tank when dropped down.

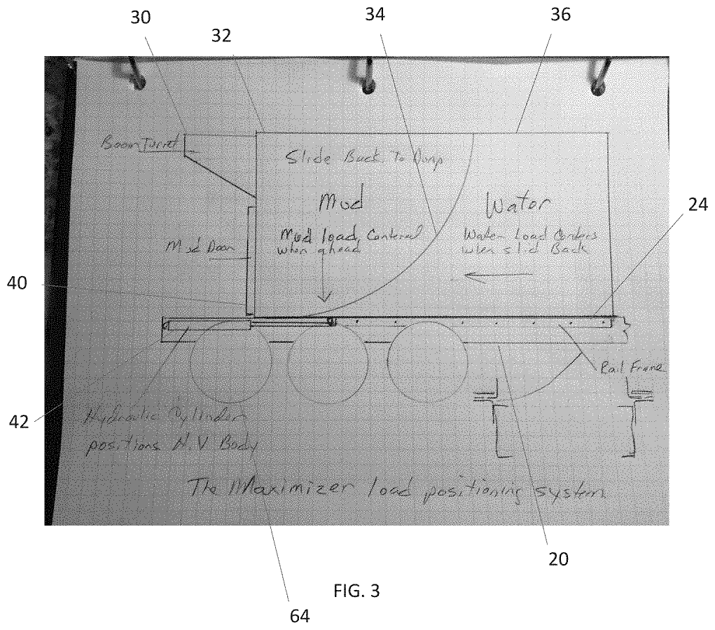

FIG. 3 shows an embodiment where the tank has two separate compartments, a mud compartment 32 and a water compartment 36 separated by a divider 34. A boom turret 30 is mounted behind the mud compartment 32. A mud door 40 allows for mud to be deposited from the back of the mud compartment 32. A hydraulic cylinder 42 operates to position the tank on the truck chassis by moving the tank on the rail frame 24.

The mud load is centred over the rear wheels when the tank is moved into the forward position as shown in FIGS. 2 and 3. The water load is centred over the rear wheels when the tank is moved into the back position as shown in FIG. 1.

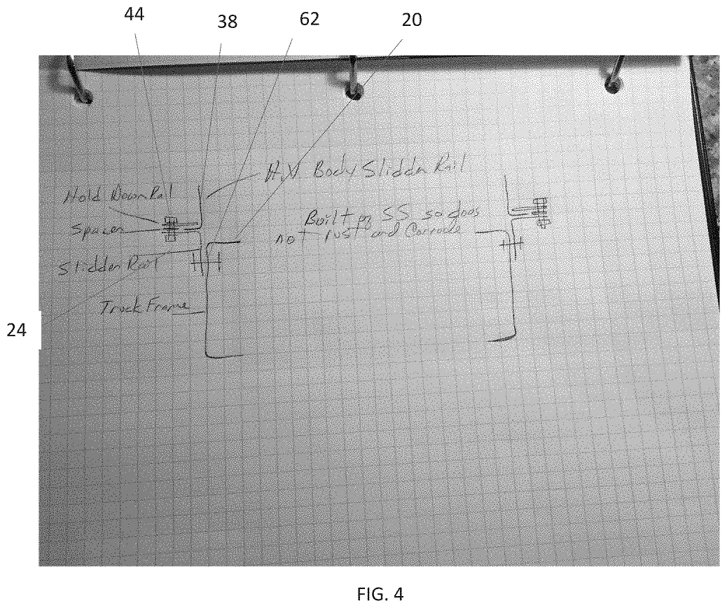

FIG. 4 shows more detail of an embodiment of the truck frame 20 and the rails 24. The slider rail 24 is connected to the truck frame by connectors 62, such as bolts. The Hydro Vac body sits on a hold down body slider rail 38. The rail components may be made of stainless steel so that they do not rust or corrode. Spacers 44 may be used between the hold down rail 38 and the slider rail 24.

This embodiment may be designed not to hoist for safety reasons meaning it is desirable to keep the mud at the back as far as possible so it is easy to unload. The basic design is that it has a sub frame that slides back and forth on sliders like a slidable 5th wheel hitch on a semi. It is pushed back and forth by a hydraulic cylinder, and has locking dogs like a fifth wheel sliding plate.

The tank can slide and shift weight to maximize either water load or mud load. Weight is now a major concern in the hydro vac industry as weight laws are strictly being enforced unlike in the past.

The mud is generally dumped out the back, since most dump sites are set up that way. So in a truck body design, the water needs to be at the front and the mud at the back unless a tank design is used which does not have to lift too high or have an unloader put in it.

FIG. 5 shows an embodiment of a square tank design to maximize capacity per length inch. Extra bracing and support is provided to increase the structural strength. The embodiment shown may be built from 5052 aluminum. Embodiments of the design have strong support and will be light and last a long time.

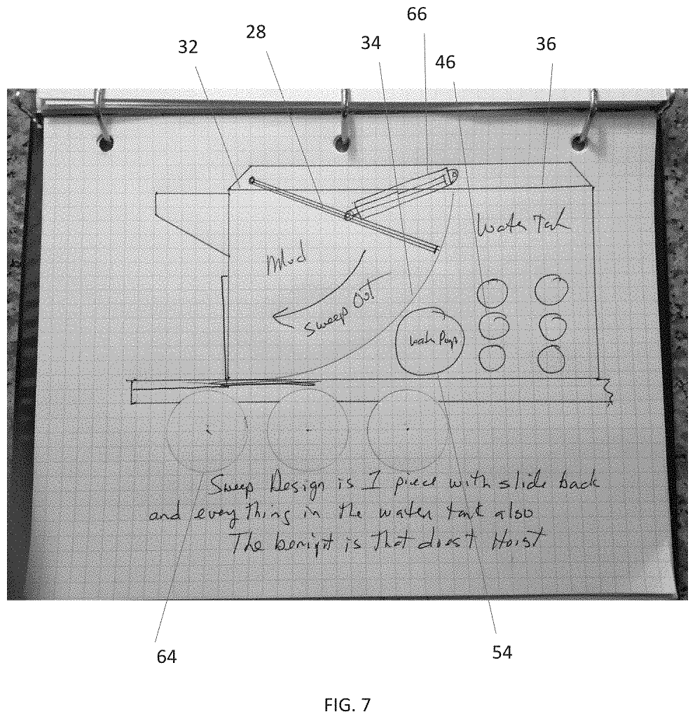

FIG. 5 shows a design employing a hoist dump mechanism. The design of the hydro vac disclosed herein may use a dump style that hoists and dumps as shown in FIG. 5 or a sweep style as shown in FIG. 7. The sweep style may be nicer in the square style because it sweeps the full width and cleans it out quickly.

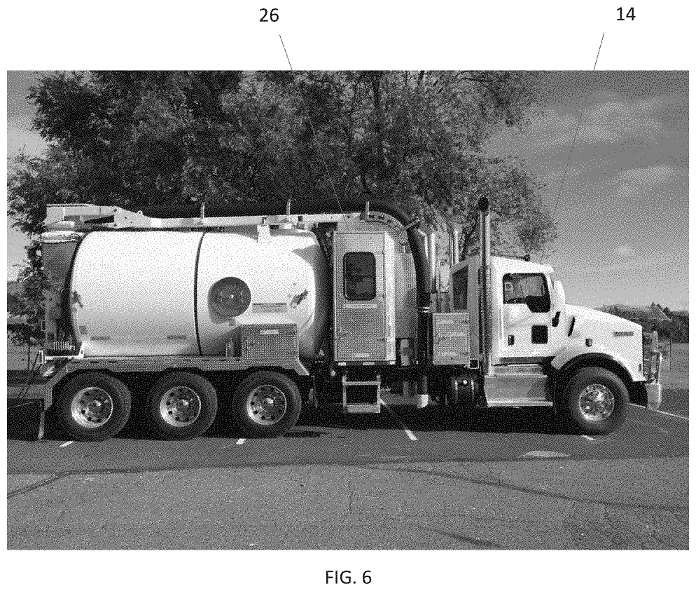

In the embodiment in FIG. 6, the mud and water compartments are two separate tanks, a mud tank 32 and a water tank 36, that both slide together on the sliding sub frame. The two tanks move together. The tanks slide back to haul a full load of water or to dump the mud tank. The tanks slide forward to haul as much mud as possible with maximum axle loads.

A cyclone 56 is located in the mud tank 32 where it takes up minimal space and empties into the mud tank area that is dirty already.

The water tank 36 is separate but also slides on the same sub frame 20. There is a split between the tanks.

A water pump 54, boiler 50 and air filters 52 are built right into the water tank 36 so they are in the tank so there are no freezing lines, less lines, and a simpler design. The air filters 52 and boiler 50 are also built into the water tank to keep from freezing, take up minimal space and less hoses and parts needed. It all adds up to saving space, weight and money.

There are tubes 46 which are slid through the water tank and welded on each side. These tubes 46 may be used to store the dig wands, dig tubes, water hoses, etc. In the embodiment shown, the tubes 46 are cylindrical. The tubes may be, for example, 12″ in diameter. These tubes take up minimal space, save room, are simple and light, and support the tank. The tubes 46 are slid in and welded so that they act to provide additional bracing for the water tank.

In the embodiment in FIG. 5, only the mud tank 32 hoists, which keeps the hoisted tank height lower when hoisted. The mud tank 32 is very short so the weight load is lower when hoisting. The sliding tank allows for the mud weight to get over the axles, but the mud tank can be short and easy to dump low.

In this embodiment there is a support 48 within the water tank 36.

The design allows the van bodies to be used for operator-related uses, including, for example, storing cloths, tools, getting warm, etc. This makes the van bodies easy to keep clean.

In this embodiment, the mud tank may be built of aluminum and braced well. The turret mount 30 for the boom bearing is all heavy stainless steel and bolted onto the aluminum frame work so nothing shears off. If the bolt holes slot or crack, it can be detected first before a boom failure occurs. The way the aluminum frame is built, will not break, but the turret section could.

Embodiments of the trucks described herein may maximize weight, space, and efficiently.

Embodiments of the design may use a drive and elevated belt drive blower which is way lighter, way simpler, and takes up way less room. That is between the Van Body that is on each side. The drive and belt drive are described in U.S. patent Ser. No. 10/246,851 issued Apr. 2, 2019, the content of which is hereby incorporate by reference in its entirety. The drive belt design allows for the blower to be put on top to allow the Silencer under it to be the support for it. Then there is way less space and piping and cost needed to get that big blower out of the way in a way that reduces the footprint. Two custom silencers may be used that bolt on each side of the Silencer for cooling air intake, which can save a lot of space and weight.

Then the back end mid tank/water tank section, slides back and forth to adjust the load to maximize the axle weights so the maximum payload is achievable. There is a slidable sub frame rail that slides the whole body unit back and forth to maximize the load being either water in the morning going to work and the mud load coming home at night or in the day time when full.

Under the door, under the Titan Advanced System LLC logo in FIG. 1, the 12″ diameter tubes 46 (FIG. 5) may be installed that go all the way across the body. In those tubes, there is the storage for the dig wands, dig tubes, hoses, extensions, water pump etc. The tubes and storage are all in the water tank section so it all stays warm. This assures that if the water is above freezing everything else is too.

In FIG. 1 the body is slid back. That is the water load at the front of the tank is slid back to take the weight off the front to haul 2400 gallons of water legally.

On the job site, an operator may slide the body all the way ahead as shown in FIG. 2 and load the mud tank to its maximum capacity to be legal going down the road. Embodiments of the design allow for a consistent and effective way to really maximize the total load every time. Other designs may provide varying degrees of maximum loading. In embodiments of the present design, mud loads can be maximized every time without being concerned about different materials, truck chassis etc. or various engineering concerns, which may otherwise require pinpointed costly designing for every situation.

FIG. 6 shows a van body 26 set back from the cab 14 to provide additional room, which allows for a larger field of view out the back window.

FIG. 7 shows a sweep 28 for clearing mud of the mud compartment 32. The sweep 28 is actuated by a hydraulic cylinder 66. A sweep design with the square outer shape of the tank provides for a full width application that keeps weight down without requiring hoisting. The curvature of the mud tank floor 34 is round so it takes the vacuum strength requirements, is easy to sweep clean and also acts as the main structural support for the unibody design combining the mud and water into one unit. Features of this design include a focused, interacting design, that is the lightest and most compact way to get that much complexity simplified and use way less space doing it.

Features of various embodiments of the design include one or more of:

A. Maximizing weight load by shifting load centers.
B. The belt drive, elevated blower design that fits between the side van bodies and reduces space needed for length, so it is possible to have a shorter turning radius for the city work that is becoming way more of the market share.
C. The water pump and lines being in the water tank makes it so much better, no freezing, lines, weight, locations.
D. The over the cab boom that lifts up straight over the cab is a big advantage also in this design, it saves space that is usually taken by the dig hose hanging down behind the cab. This allows the chassis to be very short for better turning.
E. The cross tubes for hose, wand etc storage are provided in the water tank, using way less space on the chassis and the tubes actually are bracing in the tank structure so it is very strong and requires way less actual structural support being added. And it is very simple to do.
F. An aluminum construction, which because of the way its structure is made, it becomes very strong when all assembled.
G. The boom turret mount has a stainless steel construction and bolted securely onto the aluminum frame to insure no cracking in the high torque zone.
H. A light-weight, short, simple, large scale hydro vac.

Some embodiments of the maximizer load positioning system allows the system to be very effective for load positioning depending on the load carrying, water, or different compositions of mud and allows for maximizing the axle capacity load.

Features of various embodiments of the design include one or more of the following:

1. Axle weight loads to protect expensive infrastructure.
2. Reduce cheating and overload damage to roads.
3. Offer the customers a service that costs way less because the truck can haul twice as much so the job costs are cut way down.
4. Safety, because these shorter chassis can turn way sharper when needed to reducing street accidents.
5. Less wear and tear on chassis because load is centered.
6. Light weight to meet new DOT regulations.
7. Short, to be more city friendly.
8. Strong, to last longer.
9. Simple to run and maintain
10. Safe to operate.
11. Maximize weight load per axle to meet DOT specs.

Existing Hydro Vac designs may not meet these specifications as needed. Available equipment may not meet government standards. Operators may be forced to buy what is available which may result in the operators breaking the law and paying fines.

Features of various embodiments of the design include one or more of the following:

1. Sliding body.

2. Water pump and boiler being housed in the water tank section.

3. Storage tubes in the water tank for dig tubes, wands, hoses, etc. these tubes also act as strengthening bracing in the tank to keep it as light weight as possible but strong and compact.

4. Debris unloader arm.

5. Belt drive system with air tightener which stops gear clash and allows for the blower to be mounted at the top of the HV, reducing piping and weight, and space.

In some embodiments, a combination of these features may make a light weight, but heavy-duty unit.

Immaterial modifications may be made to the embodiments described here without departing from what is covered by the claims.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

1. A hydrovac having a chassis and wheels, and a structure mounted for forward and backward movement relative to the chassis to re-distribute load on the wheels.

2. The hydrovac of claim 1 in which the structure comprises a fluid tank.

3. The hydrovac of claim 2 in which the fluid tank comprises a mud tank and a water tank.

4. The hydrovac of claim 2 in which the fluid tank is mounted on rails.

5. The hydrovac of claim 1 in which the structure is movable by a hydraulic drive.

6. The hydrovac of claim 1 further comprising a mechanical housing and the mechanical housing is movable forward and backward relative to the chassis.

7. The hydrovac of claim 3 in which the fluid tank is mounted on rails.

8. The hydrovac of claim 2 in which the structure is movable by a hydraulic drive.

9. The hydrovac of claim 3 in which the structure is movable by a hydraulic drive.

10. The hydrovac of claim 4 in which the structure is movable by a hydraulic drive.

11. The hydrovac of claim 7 in which the structure is movable by a hydraulic drive.

12. The hydrovac of claim 2 further comprising a mechanical housing and the mechanical housing is movable forward and backward relative to the chassis.

13. The hydrovac of claim 3 further comprising a mechanical housing and the mechanical housing is movable forward and backward relative to the chassis.

14. The hydrovac of claim 4 further comprising a mechanical housing and the mechanical housing is movable forward and backward relative to the chassis.

15. The hydrovac of claim 5 further comprising a mechanical housing and the mechanical housing is movable forward and backward relative to the chassis.

16. The hydrovac of claim 7 further comprising a mechanical housing and the mechanical housing is movable forward and backward relative to the chassis.

17. The hydrovac of claim 8 further comprising a mechanical housing and the mechanical housing is movable forward and backward relative to the chassis.

18. The hydrovac of claim 9 further comprising a mechanical housing and the mechanical housing is movable forward and backward relative to the chassis.

19. The hydrovac of claim 10 further comprising a mechanical housing and the mechanical housing is movable forward and backward relative to the chassis.

20. The hydrovac of claim 11 further comprising a mechanical housing and the mechanical housing is movable forward and backward relative to the chassis.
